(19) United States
(12) Patent Application Publication
(10) Pub. No.: US 2007/0280146 A1
(43) Pub. Date: Dec. 6, 2007

(54) System and method for estimating uplink signal power

(76) Inventors: Shirish Nagaraj, Cedar Knolls, NJ (US); Henry Hui Ye, Ledgewood, NJ (US)

Correspondence Address: FLETCHER YODER (LUCENT), P.O. BOX 692289, HOUSTON, TX, 77069, US

(21) Appl. No.: 11/442,853

(22) Filed: May 30, 2006

(51) Int. Cl. H04B 7/185

(52) U.S. Cl. 370/318; 370/352

(57) ABSTRACT

There is provided a system and method for estimating uplink signal power. More specifically, in one embodiment, there is provided a method comprising receiving a packet transmitted over an air interface, computing a probability that the packet has a same actual power offset as a previously decoded packet based on one or more previously received packets, and calculating a signal power estimate based on the transition probability

### BACKGROUND OF THE INVENTION

1. Field of the Invention

The present invention relates generally to telecommunications and, more particularly, to estimating the power of an uplink signal in a cellular or wireless system.

2. Description of the Related Art

This section is intended to introduce the reader to various aspects of art that may be related to various aspects of the present invention, which are described and claimed below. This discussion is believed to be helpful in providing the reader with background information to facilitate a better understanding of the various aspects of the present invention. Accordingly, it should be understood that these statements are to be read in this light, and not as admissions of prior art.

One of the paramount challenges facing modern wireless telephone systems is the rapid growth of consumer demand for data services such as Internet access, text messaging, and e-mail. In fact, consumers are demanding greater access to data-related services than ever before, and this trend is not likely to change. For example, in the coming years, consumers will likely expect their wireless telephones to provide many, if not all, of the communication features currently provided by computers (e.g., video conferencing, picture mail, etc.).

Unfortunately, building or upgrading the telecommunication infrastructure to support growing consumer demand is relatively expensive. As such, much research has been invested into determining better and more efficient methods for transmitting information over existing infrastructure. One system for more efficiently transmitting information is known as Enhanced uplink Dedicated Channel (“E-DCH”) also referred to as High Speed Uplink Packet Access (“HSUPA”). E-DCH is a modification of the Universal Mobile Telecommunication System (“UMTS”) standard that offers data rates up to 5.8 Mbps over the uplink (i.e., the transmission path between a wireless device and a node B or base station—also referred to as the “reverse link”).

The data rates of E-DCH are realizable due to the ability of the base station or NodeB to support dynamic scheduling of data rates for the different users. This scheduling is typically based on filling up the total transmission power of the users to a certain overall allowed ratio between the total power received from wireless sources at a base station and the thermal noise. This ratio is known as the Rise-over-Thermal (“RoT”) value. The available RoT that one can fill up to in any scheduling instance may depends on the RoT budget and the amount of RoT taken up by legacy channels, as well as all the E-DCH users that are in Hybrid Automatic Repeat reQuest (“HARQ”) re-transmissions. Quantifying the amount of RoT taken up by any user requires knowledge of the user's pilot received signal-to-interference-noise ratio (SINR), as well as the traffic-to-pilot power ratio (“TPR”) for the data rates of each user.

In the current specification of E-DCH (UMTS rev. 6), however, the Node B cannot know the TPR for a particular transmission until the transmission has been decoded. Rather, the Node B can only determine a nominal TPR value that is associated with the data rate of the transmission. This nominal TPR may not properly account for any power increases added by the user equipment (“UE”) prior to transmission. For example, many UEs are configured to add an additional power offset on top of the nominal TPR depending on the priority of the application being transmitted. Unfortunately, in conventional systems, the NodeB is not able to determine this power offset information (and hence the TPR used) until the packet has already been successfully decoded.

Similarly, when the UE is performing HARQ re-transmissions, the NodeB also does not know the exact TPR that was used by the UE for the re-transmission of packet until the packet is eventually decoded correctly. Due to the design of HARQ, it can take many re-transmissions before a packet is successfully decoded. Thus, at any given scheduling instant, there can be many UEs performing HARQ re-transmissions for whom the scheduler will not know their TPR.

However, the accurate scheduling of data rates dynamically in a high-speed uplink packet data system like E-DCH arises from the ability to calculate users' RoT contributions precisely as the RoT is a direct function of the TPRs used by the different users. If the TPR used to transmit a certain packet is unknown, it is not be possible for the scheduler to subtract the RoT contribution of that packet to compute the available uplink RoT for scheduling. Accordingly, one or more of the embodiments set forth below may be directed towards improving the estimation of uplink signal power (e.g., the TPR).

### SUMMARY OF THE INVENTION

Certain aspects commensurate in scope with the disclosed embodiments are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

There is provided a system and method for estimating uplink signal power. More specifically, in one embodiment, there is provided a method comprising receiving a packet transmitted over an air interface, computing a probability that the packet has a same actual power offset as a previously decoded packet based on one or more previously received packets, and calculating a signal power estimate based on the transition probability.

### BRIEF DESCRIPTION OF THE DRAWINGS

Advantages of the invention may become apparent upon reading the following detailed description and upon reference to the drawings in which:

FIG. 1 is a block diagram of an exemplary wireless telephone system in accordance with one embodiment of the invention;

FIG. 2 is a block diagram of an exemplary Node B in accordance with one embodiment of the invention; and

FIG. 3 is a flowchart illustrating an exemplary technique for estimating uplink signal power in accordance with one embodiment of the invention.

### DETAILED DESCRIPTION OF SPECIFIC EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions should be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Embodiments of the present invention are directed towards a system or method for estimating the power of an uplink signal in a wireless telephone system, such as a universal mobile telecommunication system (“UMTS”). Specifically, in one embodiment, a Node B may be configured to estimate a traffic-to-pilot power ratio (“TPR”) for a received uplink packet based on the TPR of previously transmitted packets and/or based on the a power level from one or more soft bits from the received uplink packet.

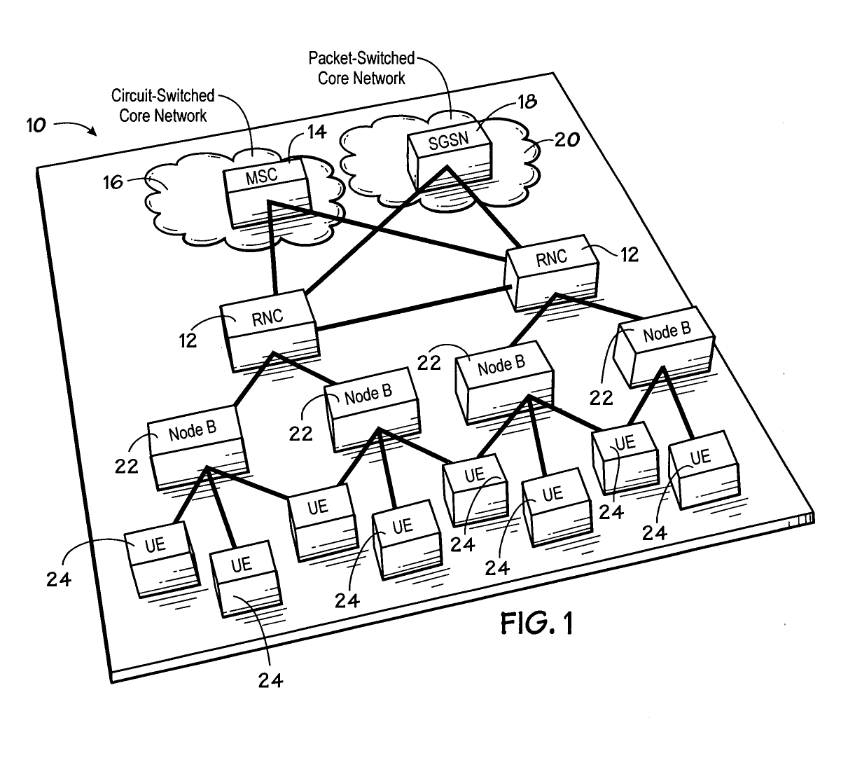

Turning now to the drawings, and referring initially to FIG. 1, a block diagram of an exemplary wireless telephone system is illustrated and generally designated by a reference numeral 10. Those of ordinary skill in the art will appreciate that the wireless telephone system 10, described below, illustrates merely one embodiment of a system configured to estimate the uplink signal power, such as a UMTS telephone system. As such, those of ordinary skill in the art will appreciate that the techniques described herein may be employed in a wide variety of wireless telephone systems including, but not limited to, Evolution Voice-Data Only (“EV-DO”), Code Division Multiple Access (“CDMA”) 2000, Evolution Voice-Data Voice (“EV-DV”), and wideband CDMA. Moreover, it will also be appreciated that while the embodiment described below involves transmission from a user equipment (“UE”) to a Node B (i.e., the uplink or reverse link), with slight modifications, the techniques described herein could also be employed for communication over the forward link (i.e., from the Node B to the UE).

In any given wireless telephone market, such as a typical metropolitan area, the wireless telephone system 10 may include at least one radio network controller (“RNC”) 12. Amongst other functions, the RNCs 12 control the use and reliability of radio resources within the wireless telephone system 10. Moreover, the RNCs 12 also may also be responsible for handoffs between RNCs 12. In one embodiment, the RNCs 12 may contain one or more application processors and/or traffic processors.

The RNC 12 may be coupled to a mobile switching center (“MSC”) 14. The MSC 14 is a switch that serves the wireless telephone system 10. The primary purpose of the MSC 14 may be to provide a data path between user equipment (“UE”) and other circuit switched telephones or data sources. The MSC 14 may be coupled to a circuit switched core network 16, which is often referred to as either a land line telephone network or a public switch telephone network.

The RNC 12 may also be coupled to a Serving GPRS Support Node (“SGSN”) 18. The SGSN 18 may be coupled to a packet-switched core network 20, such as the Internet. Amongst other things, the SGSN 18 is typically configured to tunnel/detunnel downlink/uplink IP packets between the RNC 12 and the packet switched core network 20.

The RNC 14 may also be communicatively coupled to one or more Node Bs 22. It will be appreciated, however, that in alternate embodiments, the Node Bs 22 may be replaced or supplemented with other suitable types of cellular base station or base transceiver station The Node Bs 22 are transmission and reception stations that acts as access points for network traffic from a variety of UEs 24, such as portable wireless telephones, laptop computers, vehicle-based systems, stationary voice/data system, and/or other suitable wireless communication devices. As will be described further below, one or more of the Node Bs 22 may be configured to estimate uplink signal power (e.g., the traffic-to-pilot power ratio) of transmissions over the uplink from the UEs 24.

As described above, one or more of the Node Bs 22 may be configured to estimate the traffic-to-pilot power ratio (“TPR”) of signals (e.g., packets) transmitted over the uplink. Before examining this functionality of the Node Bs 22 in greater detail, however, it may helpful to describe how the UEs 24 set the signal power for uplink signals in one exemplary embodiment—a system employing a modified version of UMTS, release 5.

A pilot signal is a signal, usually of a single frequency, transmitted over the wireless telephone system 10 for supervisory, control, equalization, continuity, synchronization, and/or other suitable purposes. In one embodiment, the UEs 24 may be configured to transmit pilot signals to the Node B 22. Typically, the pilot signals are transmitted at a constant power level. For this reason, the pilot signal power level may be employed as a reference power level, and the uplink traffic (i.e., non-pilot signals) signal power may be expressed as a ratio between the constant pilot power level and the traffic power level or TPR. For example, a TPR of 2.0 would indicate that traffic signals are being transmitted over the uplink at twice the power level as the pilot signal.

A variety of suitable factors may affect the TPR selected by each of the UEs 24 for a particular uplink transmission. In one embodiment, each of the UEs 24 may be programmed with a plurality of nominal TPR values—one of which is selected based on the data rate in use by the UE 24. For example, if the UE 24 is transmitting at a higher data rate or if the UE 24 is transmitting high priority data, it may select a higher nominal TPR than when it is transmitting at a lower data rate or with a lower priority.

Moreover, as most people are aware, modern UEs 24 may be configured to transmit data for a variety of different types of applications, such as voice conversations, file transfers (picture downloading/uploading), web pages, video conferencing, and so forth. Each of these types of data is typically transmitted over the same uplink but with different quality of service (“QoS”) parameters. For example, the QoS parameters for a voice conversation may include quick transmission but tolerate errors; whereas file transfers can be transmitted slower but do not tolerate errors. Moreover, the current specification of the Enhanced uplink Dedicated CHannel (“E-DCH”) of the UMTS, release 5 also allows the UEs 24 to multiplex multiple applications (e.g., voice calls, file transfers, web pages, and so forth) into a single packet. Each of these applications, however, may have its own QoS requirements, which in turn may be translated to different power offsets.

To account for the QoS requirements for each of the different applications, the UEs 24 may also be configured to multiply the nominal TPR by a respective power offset (hereafter also referred to as “Δ”). For example, in one embodiment, the UEs 24 may have N different HARQ profiles based on QoS parameter, each having its own power offset, given by the set D={Δ₁, Δ₂, . . . , Δ_{N}}. As such, if the packet to be transmitted by the UE 24 contains video conferencing data, the UE 24 may be configured to transmit the packet at the nominal TPR multiplied by a power offset of 3 dB—resulting in an actual TPR of twice the nominal TPR value. In other words, the actual TPR for the packet received by the Node B 22 will be the product of the nominal TPR and the power offset.

As described above, however, due to restrictions in the UMTS standard, the UEs 24 are only able to transmit the value of the nominal TPRs via control signal and not the actual power offset. The information of which applications have been included or multiplexed into the packet is contained in the header of that packet, which unfortunately cannot be read until the packet is successfully decoded. Thus, the NodeB 22 can only determine actual TPR used after the packet has been successfully decoded.

Unfortunately, for a variety of functions, it is advantageous to know the actual TPR (as closely as possible) prior to decoding the packet. First, the high data rates promised by E-DCH are realizable due to the ability of the Node B 22 to support dynamic scheduling of data rates for the different UEs 24. This scheduling is typically based on filling up the UEs 24 power level to a certain overall allowed Rise-over-Thermal (“RoT”) value. The available RoT that the Node B 22 can fill up to in any scheduling instance is a function of the RoT budget and the amount of RoT taken up by legacy channels, as well as all the E-DCH users that are in Hybrid Automatic Repeat reQuest (“HARQ”) re-transmissions. Quantifying the amount of RoT taken up by any one of the UEs 24 requires knowledge of the user's pilot received signal-to-interference+noise ratio (“SINR”) as well as the actual TPR for the data rate that the UE 24.

However, as described above, the Node B 22 does not know the actual TPR until after the packet is decoded. By the design of HARQ, it can take many re-transmissions before a packet is successfully decoded. Thus, at any given scheduling instant, there would be many users in HARQ re-transmissions for whom the scheduler will not know the actual TPR. The accurate scheduling of users rates dynamically in a high-speed uplink packet data system like E-DCH arises from the ability to calculate the UEs' 24 RoT contributions. However, in conventional systems, the Node B must use the nominal TPR for this calculation—leading to less precise operation by the scheduler. As such, estimating the actual TPR can increase the precision of the scheduler in the Node B, and, thus, may advantageously increase the available bandwidth of the uplink.

In addition, many types of Node Bs 22 employ decoding systems that may also benefit from estimation of the actual TPR. For example, one encoding/decoding technique, known as turbo coding, enables data to be transmitted within 0.7 dB of the signal to noise ratio (“SNR”) as dictated by the Shannon limit, which gives the minimum theoretical SNR for error-free transmission. The accuracy of turbo decoding, however, is dependent to some extent on the accuracy TPR values used in the decoding process. As such, employing an estimated actual TPR (as opposed to the nominal TPR) may increase the accuracy of the decoding within the Node B 22. This increase in accuracy may reduce the number of retransmissions and, thus, increase the throughput of the Node B 22.

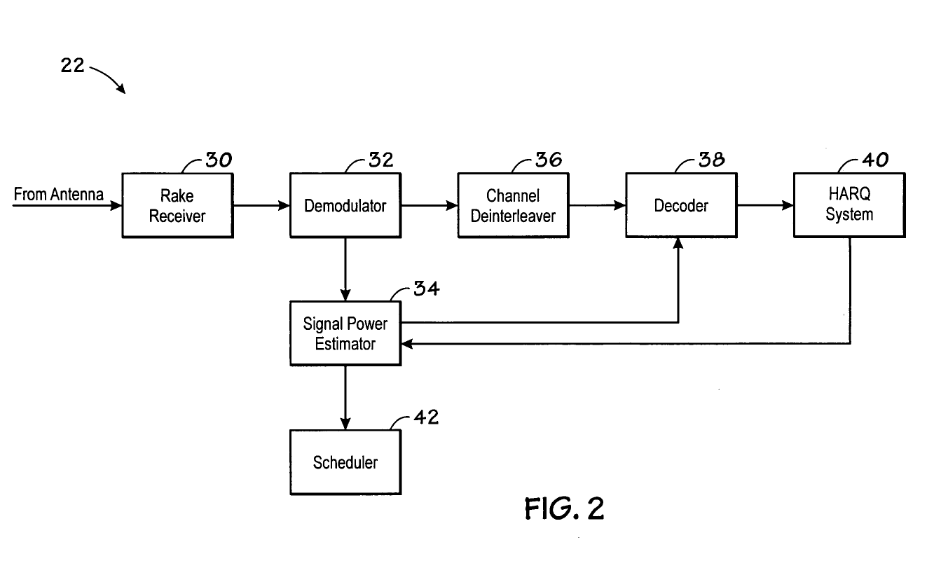

Returning now to the drawings, FIG. 2 is a block diagram illustrating the exemplary Node B 22 in accordance with one embodiment. As shown in FIG. 2, the Node B 22 may include a RAKE receiver 30 that includes several RAKE fingers that each attempt to extract a copy of the transmitted signal out of the multiple copies of the transmitted signal that may make up the uplink signal. The RAKE receiver 30 may scale the relative weight for each of the multiple copies based on a channel estimate for each RAKE finger. The RAKE receiver 30 may then combine a weighted sum of the signals at the output of each RAKE finger to form a unified replica of the transmitted uplink signal. This unified replica may be in the form of a series of discrete time signals.

A demodulator 32 may calculate soft bits for the series of discrete time signals output from the RAKE receiver 30. A soft bit is the logarithm of the ratio of the probability that a bit is equal to one and the probability that the bit is equal to zero. In one embodiment, this probability is a logarithm of the likelihood ratio (“LLR”). For example, if the soft bits were 0.8 for one and 0.2 for zero, the demodulator 32 would be indicating that there is an 80% chance that the bit is one and a 20% chance that the bit is zero. The LLR for the example above, would be

$$log ( \frac{0.8}{0.2} )$$

or 0.6021 where the logarithm is to the base 10. A positive LLR may indicate a greater probability that the soft is supposed to be a one, and a negative LLR may indicate a greater possibility the soft bit is supposed to be zero. In addition, the demodulator 32 may also be configured to measure the energy y(t) of the soft bits. This energy measurement may then be transmitted to a signal power estimator 34. As will be described in greater detail below, the signal power estimator 34 may be configured to apply y(t) in the estimation of actual TPR of the uplink signal. In one embodiment, the signal power estimator 34 may be configured to transmit the actual signal power estimate to a decoder 38 (described further below) and scheduler 42, which, as those of ordinary skill in the art will appreciate, may be configured to schedule transmissions between the Node B 22 and the UE 24

The soft bits from the demodulator 32 may be routed to a channel de-interleaver 36. As will be appreciated by those of ordinary skill in the art, the channel de-interleaver 36 may be employed to compensate for the effects of an interleaver in the UE 24 and to place the soft bits back into their original order.

After the soft bits has passed through the channel de-interleaver 36, it is routed to a decoder 38. In one embodiment, the decoder 38 includes a turbo decoder. The decoder 38 may be configured to refine the LLRs for each soft bit in the signal into a hard bit (i.e., a digital one or a zero) that is transmitted to a HARQ system 40. In one embodiment, the decoder 38 may employ a TPR estimate provided by the signal power estimator 34 in the decoding process.

The HARQ system 40 may be configured to attempt to rebuild the transmitted packet from the hard bits produced by the decoder 38. If the HARQ system 40 is able to rebuild the packet, it may direct the Node B to acknowledge the receipt of the packet to the UE 24. In addition, the HARQ system 40 may be configured to transmit header data from the packet to the signal power estimator 34. From this header data, the signal power estimator may be able to determine the actual TPR for the packet. As described in more detail below, this information may be employed to estimate the actual TPR of future packets. If, on the other hand, the HARQ system 40 is not able to rebuild the packet, it may direct the Node B 22 to transmit a non-acknowledgment to the UE 24 prompting a retransmission of the packet.

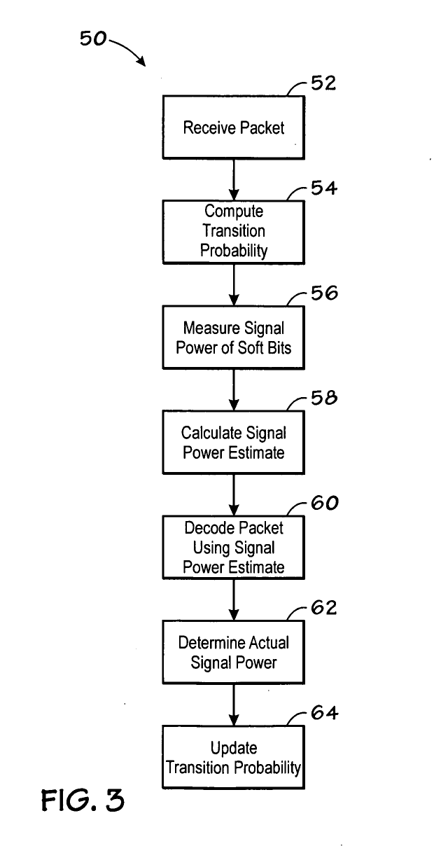

Turning next to FIG. 3, a flow chart of an exemplary technique for estimating uplink signal power in accordance with one embodiment is illustrated and generally designated by a reference numeral 50. In one embodiment, the technique 50 may be performed by the Node B 22. However, in alternate embodiments, other suitable telecommunication systems, such as the RNC 12, a base station, a base transceiver station, or the like may be configured to execute the technique 50.

As indicated by block 52 of FIG. 3, the technique 50 may begin with the Node B 22 receiving a uplink packet from the UE 24. Next, the signal power estimator 34 may compute a transition probability estimate for the received packet, as indicated by block 54. In one embodiment, the transition probability is the probability that the next packet will or will not have the same actual power offset as the packet that was decoded most recently. As described below, in one embodiment, the transition probability may be computed based on one or more previously received packets.

For example, as will be appreciated, the received packet contains a relatively small portion of the total uplink transmission from the UE 24 to the Node B 22. As such, it can be assumed that the actual TPR (i.e., nominal TPR plus the power offset) used in the current transmission is correlated at least some portion of the time to the TPR used in previous transmissions from the UE 24. This correlation can be represented as a list of probabilities that the received packet will have a particular power offset based on a history of the actual power offset of the previously received packet. For example, if nine out of the past ten packets transmitted with a power offset of 3 dB were followed by another packet with a power offset of 3 dB and one of the past ten was followed by a packet transmitted with a power offset of 1 dB, there is a 0.9 probability that the received packet will have a power offset of 3 dB and a 0.1 probability that the received packet will have a power offset of 1 dB, if the previously packet had a power offset of 3 dB. It will be appreciated, however, that this probabilities list will only include the probabilities from the previously successfully decoded packet to the current packet, as the actual TPR of an unsuccessful packet is not available.

In one embodiment, the transition probability list may be represented as a first-order Markov process. First, the current power offset used for the n^{th} successful packet can be defined as Δ(t), which belongs to the set D. Further, it is defined that the probability that Δ(t) is equal to, say Δᵢ, given that the previous successful packet had a power offset of Δₖ. That is:

P_{i|k}=P[Δ(t)=Δᵢ|Δ(t−1)=Δₖ] i, k=1, 2, . . . , N. (1)

From this equation, a recursive estimate of the above probabilities can be computed as follows:
1. At t=0, assign:
   a. P_{i|i}(0)=1 for all i=1, 2, . . . , N; and P_{i|k}(0)=0; for all i not equal to k.
   b. Nₖ(0)=1 for all k=1, 2, . . . , N.
2. After successfully decoding the t^{th} packet, for t=1, 2, . . . , the probabilities can be updated as follows:
   a. If Δ(t−1)=Δₖ, then for that index k, do:

Nₖ(t)=Nₖ(t−1)+1

P_{i|k}(t)=[(Nₖ(t)−1)/Nₖ(t)]P_{i|k}(t−1)+[1/Nₖ(t)]δ(Δ(t)−Δᵢ),
where, δ(j)=1, if j=0; and
   δ(j)=0 else.
b. For all other k, no update, i.e., Nₖ(t)=Nₖ(t−1), and P_{i|k}(t)=P_{i|k}(t−1).
   It will be appreciated, however, that a variety of suitable techniques may be used to compute the transition probability, and, as such, the technique described above are not intended be exclusive. For example, in one alternate embodiment, the averaging of the probabilities is performed with an exponential filter.

The Node B 22 may also be configured to measure the signal power of the soft bits from the received packet, as indicated by block 56. As described in greater detail below, the measured signal power of the soft bits may employed by the Node B to calculate a signal power estimate.

The technique 50 may also be configured to calculate an uplink signal power estimate, as indicated by block 58. In one embodiment, the uplink signal power estimate may be calculated using minimum means squared error (“MMSE”) estimation. Specifically, the MMSE estimation may involve attempting to minimize the deviation between the true and estimated loading contributions, where the loading for a certain user may be given as:

L(t)=Ecp/Io(t)TPRₙₒₘ(t)Δ(t),

where Ecp/Io(t) is the pilot energy per chip to total interference ratio, TPRₙₒₘ(t) is the nominal TPR for the data rate of the received packet, and Δ(t) is the power offset used by the UE 24 for transmitting a packet at time t. The MMSE approach seeks an estimated power offset Δₑₛₜ(t), such that,

E[|Δ(t)−Δₑₛₜ(t)|²] is minimized.

where E[.] denotes the expectation operation (with respect to the underlying probability distributions). This estimate also attempts to minimize the deviation in the loading value L(t) and its estimate if the Ecp/Io(t) and TPRₙₒₘ(t) are known accurately. Because, as described above, the power offset depends statistically on the previously used additional power offset, Δ(t−1), and the soft-bits of the current transmission, y(t), it is straightforward to calculate that the conditional mean estimate that minimizes the mean-squared error is given by:

Δₑₛₜ(t)=E[Δ(t)|Δ(t−1)=Δₘ,y(t)]

Assuming that the previous additional power offset was some arbitrary, but known, value Δₘ from the set D. This estimate can be computed as:

Δₑₛₜ(t)=Δ₁P[Δ(t)=Δ₁|Δ(t−1)=Δₘ,y(t)]+ . . . +Δ_{N}P[Δ(t)=ΔN|Δ(t−1)=Δₘ,y(t)]

Wherein each of the above probabilities can be computed as:

$$P [ Δ ( t ) = {Δ}_{i} \vert Δ ( t - 1 ) = {Δ}_{m} , y ( t ) ] = f ( y ( t ) \vert Δ ( t ) = {Δ}_{i} , Δ ( t - 1 ) = {Δ}_{m} ) P [ Δ ( t ) = {Δ}_{i} \vert Δ ( t - 1 ) = {Δ}_{m} ] / f ( y ( t ) \vert Δ ( t - 1 ) = {Δ}_{m} ) = f ( y ( t ) \vert Δ ( t ) = {Δ}_{i} ) {P}_{i \vert m} ( t - 1 ) / {\sum }_{j = 1 to N} f ( y ( t ) \vert Δ ( t ) = {Δ}_{j} ) {P}_{j \vert m} ( t - 1 )$$

### Note that the relations illustrated above work out because MMSE estimation involves a Markov chain in the random variables, Δ(t−1)→Δ(t)→y(t). Here, f(.) denotes a probability density function.

The last quantity remaining to be computed is the calculation of f(y(t)|Δ(t)=Δⱼ) for all j=1, 2, . . . , N. For this, it can be assumed that the statistic y(t) is computed as:

y(t)=Σzₖ(t)²/K, where

zₖ(t)=[SF Ecp/Io(t)TPRₙₒₘ(t)Δⱼ(t)]^{1/2}sₖ(t)+vₖ(t).

Here, K is the total number of de-spread traffic symbols in a transmission time, sₖ(t) is the traffic symbol belonging to a binary alphabet, and the noise samples vₖ(t) are independent and identically distributed real Gaussian random variables with zero mean and unit variance. Thus, it follows that y(t) is a non-central Chi-squared distributed random variable, with the non-centrality parameter depending on Δⱼ(t). Using this, it can be computed that f(y(t)|Δ(t)=Δⱼ), and hence, the MMSE estimate as defined above.

In another embodiment, the uplink signal power estimate may be calculated using Maximum Aposteriori Probability (“MAP”) algorithm (also referred to as the BCJR algorithm). In the MAP approach, the power offset is selected that results in the largest posterior probability. That is:

Δₑₛₜ(t)=arg max_{i=1 to N}P[Δ(t)=Δᵢ|Δ(t−1)=Δₘ,y(t)]=arg max f(y(t)|Δ(t)=Δᵢ)P_{i|m}(t−1)

This will actually maximize the correct detection probability (P[Δₑₛₜ(t)=Δ(t)]). It should be noted, however, that the individual components in the calculations are the same as what has been outlined with regard to the MMSE algorithm above. In addition, the MAP approach has a slight computational advantage in the sense that the term Σ_{j=1 to N} f(y(t)|Δ(t)=Δⱼ) P_{j|m}(t), present in the MMSE equations, need not be computed here.

In still other embodiments, the uplink signal power may be estimated using other suitable statistical techniques. Moreover, alternate techniques may also be employed if either y(t) is unavailable, the previous packet power offset is not available, or y(t) and the transition probabilities are unavailable. These cases may occur in an implementation due to lack of computational resources, a lack of knowledge of the previous decoded packets (from memory limitations, for example), and the like.

First, in the event that y(t) is not available, it can be assumed that the statistic y(t) is independent of Δ(t) (and hence, independent of Δ(t−1)). In this situation, the MMSE estimate becomes:

Δₑₛₜ(t)=Δ₁P_{1|m}(t−1)+Δ₂P_{2|m}(t−1)+ . . . +Δ_{N}P_{N|m}(t−1),

and the MAP estimator results in the following:

Δₑₛₜ(t)=arg maxᵢP_{i|m}(t−1),

which chooses the additional power offset corresponding to the most probable value given the past realization.

Second, in the case where Δ(t−1) is not available, the a priori probabilities, in terms of P_{i|m}(t), will not be available. As such, all of the a priori possibilities can be made equal to 1/N (uniform prior). Then, the MMSE estimator will be of the form:

Δₑₛₜ(t)=Σ_{i=1 to N}Δᵢf(y(t)|Δ(t)=Δᵢ)/Σ_{j=1 to N}f(y(t)|Δ(t)=Δⱼ)

By making the priors uniform, the MAP estimator will become the Maximum Likelihood (“ML”) estimator, that is:

Δₑₛₜ(t)=arg maxᵢf(y(t)|Δ(t)=Δᵢ)

Third, in the case where both y(t) and P_{i|m}(t−1) are not available, it can be assumed that Δ(t−1)=Δₘ. As such, the following substitution can be performed:

P_{i|m}(t−1)=1, for i=m,
0, else.

### For this substitution, it is straightforward to note that both the MMSE and MAP estimators will result in estimating Δ(t)=Δ(t−1)=Δₘ.

Returning now to FIG. 3, after calculating the signal power estimate, the Node B 22 may decode the received packet using the calculated estimate, as indicated in block 60. Next, if the received packet is successfully decoded, the Node B 22 may determine the actual signal power (i.e., the actual TPR) from the information in the header of the received packet, as indicated in block 62. Once the actual signal power is determined, the Node B 22 may use this information to update the transition probabilities (see block 54 above), as indicated by block 64. In this way, the transition probabilities employed by the Node B 22 may be continuously updated as the Node B 22 successfully decodes new packets.

Many of the modules or blocks described above with reference to FIGS. 1, 2, and/or 3 may comprise code adapted to implement logical functions. Such code can be embodied in a tangible computer-readable medium for use by or in connection with a computer-based system that can retrieve the instructions and execute them to carry out the previously described processes. In the context of this application, the computer-readable medium can contain and/or store the instructions. By way of example, the computer readable medium can be an electronic, a magnetic, an optical, an electromagnetic, or an infrared system, apparatus, or device. An illustrative, but non-exhaustive list of computer-readable mediums can include an electrical connection (electronic) having one or more wires, a portable computer diskette, a random access memory (“RAM”) a read-only memory (“ROM”), an erasable programmable read-only memory (“EPROM” or Flash memory), an optical fiber, and/or an optical disk. It is even possible to use paper or another suitable medium upon which the instructions are printed. For instance, the instructions can be electronically captured via optical scanning of the paper or other medium, then compiled, interpreted or otherwise processed in a suitable manner if necessary, and then stored in a computer memory.

Moreover, while the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

We claim:

1. A method comprising:
receiving a packet transmitted over an air interface;
computing a probability that the packet has a same actual power offset as a previously decoded packet based on one or more previously received packets; and
calculating a signal power estimate based on the transition probability.

2. The method, as set forth in claim 1, wherein computing the probability comprises computing a list of probabilities based on a history of previously received packets with a same nominal traffic-to-pilot power ratio as the received packet.

3. The method, as set forth in claim 2, wherein computing the list of probabilities comprises computing the probability that a power offset of the received packet matches a power offset of the previously received packet.

4. The method, as set forth in claim 1, wherein calculating the signal power estimate comprises calculating a power offset estimate based on a nominal traffic-to-pilot power ratio and a power offset of the previously received packet.

5. The method, as set forth in claim 1, comprising measuring a signal power of a soft bit from the received packet, wherein the signal power estimate is based at least partially on the measured signal power of the soft bit.

6. The method, as set forth in claim 1, wherein calculating the signal power estimate comprises calculating a minimum mean squared error of the transition probability.

7. The method, as set forth in claim 1, wherein calculating the signal power estimate comprises calculating a maximum aposteriori probability for the transition probability.

8. The method, as set forth in claim 1, comprising decoding the received packet based on the signal power estimate.

9. The method, as set forth in claim 8, comprising:
determining an actual signal power from the decoded packet; and
updating the probability based on the actual signal power.

10. The method, as set forth in claim 1, wherein receiving the packet comprises receiving the packet over an E-DCH uplink.

11. The method, as set forth in claim 1, comprising transmitting the signal power estimate to a scheduler.

12. A communication system configured to:
receive a packet transmitted over an air interface;
compute a probability that the packet has a same actual power offset as a previously decoded packet based on one or more previously received packets; and
calculate a signal power estimate based on the transition probability.

13. The communication system, as set forth in claim 12, wherein the communication system is configured to calculate the power offset estimate based on a nominal traffic-to-pilot power ratio and a power offset of the previously received packet.

14. The communication system, as set forth in claim 12, wherein the communication system comprises a Node B.

15. The communication system, as set forth in claim 12, wherein the communication system comprises a base station.

16. The communication system, as set forth in claim 11, comprising a scheduler, wherein the communication system is configured to transmit the signal power estimate to the scheduler.

17. The communication system, as set forth in claim 11, wherein the communication system is configured to:
measure a signal power of a soft bit from the received packet; and
calculate the signal power estimate based on the measured signal power of the soft bit.

18. A tangible machine readable medium comprising:
code adapted to receive a packet transmitted over an air interface;
code adapted to compute a probability that the packet has a same actual power offset as a previously decoded packet based on one or more previously received packets; and
code adapted to calculate a signal power estimate based on the transition probability.

19. The tangible medium, as set forth in claim 18, comprising code adapted to receive the received packet over an E-DCH uplink.

20. The tangible medium, as set forth in claim 18, comprising code adapted to calculate a power offset estimate based on a nominal traffic-to-pilot power ratio and a power offset of the previously received packet.
